(19) United States
(12) Patent Application Publication
(10) Pub. No.: US 2004/0003217 A1
(43) Pub. Date: Jan. 1, 2004

(54) Data processing device with branch prediction mechanism

(75) Inventor: Masaki Ukai, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/349,930

(22) Filed: Jan. 24, 2003

(30) Foreign Application Priority Data
Jun. 28, 2002 (JP) 2002-191433

(51) Int. Cl. G06F 9/00

(52) U.S. Cl. 712/239

(57) ABSTRACT

Phantom entries of entries in a branch history are completely detected using a flag identifying a phantom and a flag detecting the misalignment between the address of an instruction and an address where a branch has been predicted, which are provided for a queue executing branch instruction and controlling a phantom, and if the entries are not needed, they are erased. If there is an instruction that branches control flow, a phantom entry is intentionally created and instruction pre-fetching is applied to the entry.

### BACKGROUND OF THE INVENTION

1. Field of the Invention

The present invention relates to a data processing device adopting a branch prediction mechanism (branch history, etc.) in order to execute instruction stream, including branches at high speed, and in particular, relates to a method canceling the registration of an entry badly affecting performance.

2. Description of the Related Art

The performance of a data processing device adopting an advanced pipeline processing method has been improved by speculatively processing subsequent instructions without waiting for the termination of the current instruction. If it is not determined whether a branch instruction will branch control flow or to which address it will branch control flow, then the subsequent instruction cannot be fetched before the branch instruction has completed. In order to solve this problem, a branch prediction mechanism is introduced and by predicting the branch direction of the branch instruction or the branch destination instruction address, performance has been further improved. For example, in Japanese Patent Laid-open Publication No. 6-89173, improved performance has been obtained by providing a branch prediction mechanism (branch history) independent from cache memory.

However, as the scale of a branch history increases, performance often degrades depending on its content.

In particular, since a branch history is provided independent from cache memory, a TLB (Translation Lookaside Buffer) and the like, usually updated information is not reflected in the branch history or reflection cannot catch up with all updates even when the state of an instruction area is updated by updating an instruction string. As a result, branches are predicted for instructions other than branch instructions for the following reasons:

Another instruction is loaded into an address where there was a branch instruction

Another program is dispatched to a logical address by modifying the TLB Such an entry existing in a branch history is called a phantom entry.

FIG. 1 shows the basic mechanism causing a phantom entry.

A conventional branch history does not necessarily erase a phantom entry, and a phantom will also disappear when an old entry is erased by a replacement operation accompanying new entry registration.

However, as shown in FIG. 1, if there are programs A and B, and a processor executes them in parallel by time divisional control, some times program A is executed and other times program B is executed. In FIG. 1, it is assumed that there is a branch instruction at the address 1,500 of program A. In this case, when detecting the address 1,500, a branch prediction mechanism, such as a branch history, predicts a branch. Since the instruction stored in 1,500 is a branch instruction, it is correct to predict a branch only when program A is executed. However, when in time slice control, the instruction execution target shifts from program A to program B, a branch prediction mechanism, such as a branch history, automatically predicts a branch, based only on the result of the address detection without waiting for instruction decoding, when detecting 1,500. Since, as shown in FIG. 1, an add instruction that requires no branch prediction is currently stored in 1,500 of program B. Therefore, if a branch history does not store entries correctly, it mistakes the add instruction of program B that requires no branch prediction for the branch instruction of program A and predicts a branch.

When in instruction execution control, a branch is predicted in this way although the instruction is not a branch instruction, a process for correcting the mistake is needed and costs increase. Therefore, if such a phantom entry is not erased as soon as it is detected, the performance of the branch history that was developed to improve performance actually degrades. In particular, if the entry capacity of the branch history is small, many phantom entries are left unprocessed as required capacity and amount of association increases, although time needed to erase a phantom entry by a replacement operation and the like is originally short, which is a problem.

### SUMMARY OF THE INVENTION

It is an object of the present invention to provide a device efficiently erasing phantom entries in order to solve the problem described above and to improve the speed of a data processing device.

The first data processing device of the present invention has a branch prediction mechanism. The data processing device comprises judgment unit judging whether a target instruction is a branch instruction; and phantom erasure unit erasing a branch prediction entry corresponding to an instruction to be stored in the branch prediction mechanism if it is judged that the target instruction is not a branch instruction.

The second data processing device of the present invention has a branch prediction mechanism. The data processing device comprises queue unit extracting an instruction and storing it for execution; detection unit judging whether an address where a branch has been predicted is on the boundary of the instruction word stored in the queue unit when the branch has been predicted for the instruction stored in the queue unit; and misalignment erasure unit erasing branch prediction entries to be stored in a branch prediction mechanism on which the branch prediction is based, if it is judged that the address where a branch has been predicted is not on the boundary of the instruction word.

The third data processing device of the present invention has a branch prediction mechanism. The data processing device comprises phantom target instruction detection unit detecting a branch instruction that is not executed at high speed or a non-branch instruction that branches control flow; and phantom entry generation unit creating a branch prediction entry to be stored in a branch prediction mechanism, based on an entry corresponding to the instruction detected by the phantom target instruction detection unit and adding it to the branch history. The data processing device improves processing speed by performing instruction pre-fetching using the branch prediction entry.

According to the present invention, phantom entries, which are extra entries in a branch history to be stored in a branch prediction mechanism, can be completely erased, and even when time division control is applied to an application and a data processing device executes the application, incorrect branch prediction can be avoided. Therefore, time needed to correct incorrect branch prediction can be saved and accordingly, the performance of the data processing device can be improved.

Execution speed can also be improved by intentionally registering an instruction whose processing takes much time in a branch history as a phantom entry and by pre-fetching the instruction, and accordingly, the performance of the data processing device can also be improved.

### BRIEF DESCRIPTION OF THE DRAWINGS

FIG. 1 shows the basic mechanism causing a phantom entry;

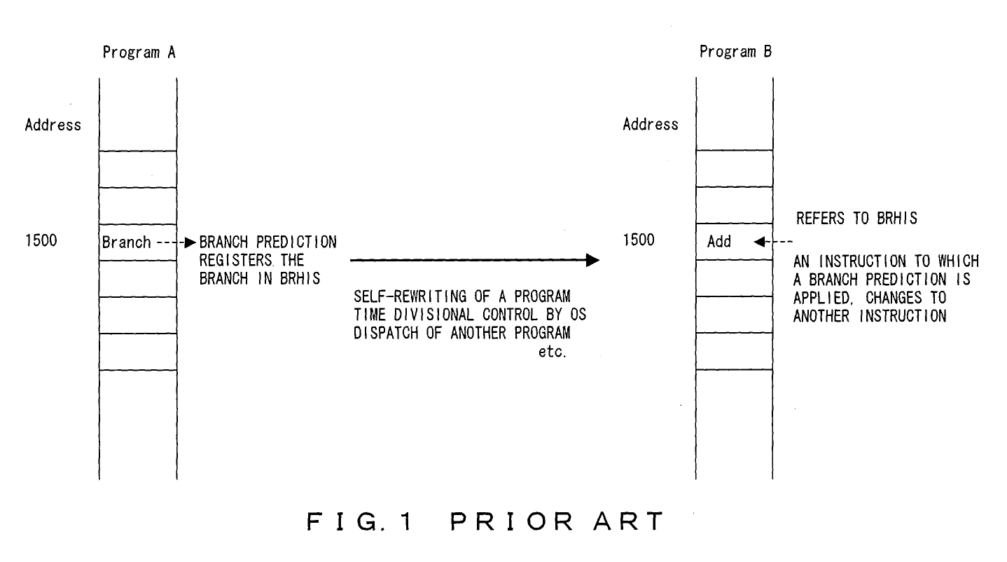

FIG. 2 shows a case where a branch is not predicted on an instruction boundary;

FIG. 3 shows the basic configuration of a data processing device in the preferred embodiment of the present invention;

FIG. 4 shows an example of a circuit for creating BRHIS-Hit and Hit-Offset (MISALIGN Half-Word);

FIG. 5 shows an example of the structure of a queue RSBR for executing a branch instruction and controlling a phantom;

FIG. 6 shows an operation to report the completion of branch execution;

FIG. 7 shows an example of a circuit for generating an entry erasure instruction signal;

FIG. 8 shows a configuration used to intentionally create a phantom entry; and

FIG. 9 shows an example of a circuit for generating a BRHIS update signal used when a phantom entry is intentionally created.

### DESCRIPTION OF THE PREFERRED EMBODIMENTS

Branch prediction is closely related to the execution control of branch instruction. A branch control unit knows whether as a result of a branch process, the branch prediction was accurate and has a data update control unit for updating a branch history. This configuration has been put into practical use (see Japanese Patent Laid-open Publication No. 2000-282710).

A device that reports the accuracy of branch prediction to a branch prediction unit (branch history) by creating in the branch control unit an entry corresponding to an instruction whose branch has been predicted although the instruction is not a branch instruction is disclosed in Japanese Patent Laid-open Publication No. 2000-282710. Therefore, this device is used in the present invention.

Normal branch history update is disclosed, for example, in Japanese Patent Laid-open Publication No. 2000-172503. Therefore, this is also used in the present invention.

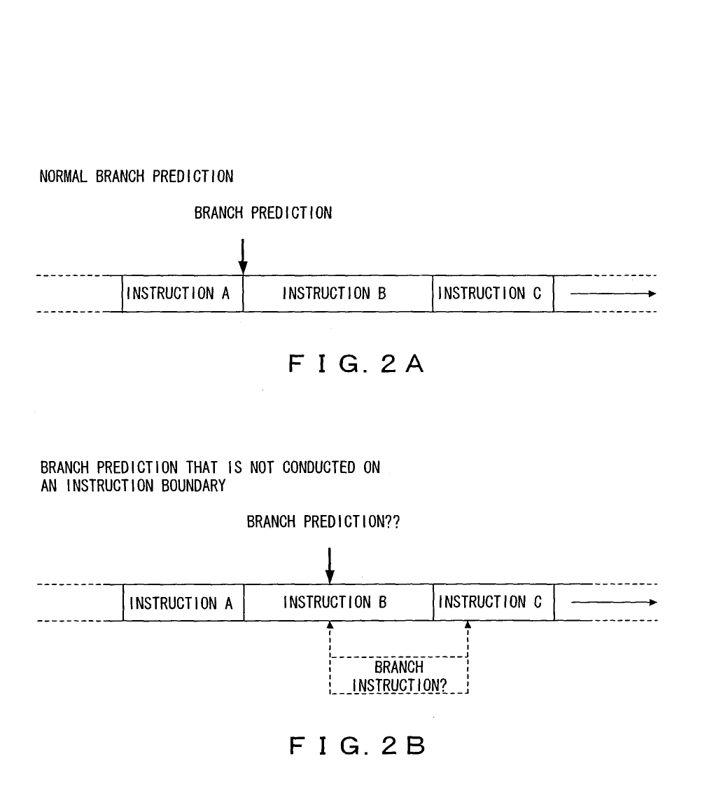

Some devices adopt a set of instructions, whose length each is constant and variable (have a plurality of instruction lengths). In the case of a micro-architecture adopting a branch history in such an instruction set, as shown in FIG. 2, a branch is sometimes predicted in a position that is not on an instruction boundary depending on the situation. This is also a kind of a phantom entry and is a more difficult problem if the situations described above are considered.

FIGS. 2A and 2B show a case where a branch is not predicted on an instruction boundary.

In the normal branch prediction shown in FIG. 2A, a branch is predicted on the boundary between two instructions. However, if another program is loaded and a branch history is left un-updated as described in the paragraph “Description of the Related Art”, branch prediction is conducted in a position other than an instruction boundary, as shown in FIG. 2B. This means that if in a previous program, a branch instruction is located in the part indicated by dotted lines in FIG. 2B, the instruction boundary of the previous program is not always the instruction boundary of a subsequent program after the subsequent program is read.

In this case, sometimes a phantom entry in the corresponding branch history cannot be erased unless information accurately reproducing the predicted address, such as offset information sent from an instruction boundary, is stored.

There are also instructions which branch or interrupt control flow like a branch instruction, such as an exception (software trap instruction). When the address is modified, the processor state of such instruction is simultaneously modified. Therefore, in this case, a branch instruction control unit alone sometimes cannot process such an instruction at high speed.

If such a special instruction can also be registered in a branch history, predicted branch destination can be fetched using the information obtained by retrieving data from the branch history. In this way, an instruction to be executed in an instruction cache area can be read in advance and cache miss penalty can be reduced.

As described above, by using a phantom entry erasure method according to the preferred embodiment of the present invention, instructions that the branch execution control unit does not execute can be consistently executed without interfering with other operations, including the prediction of another branch instruction.

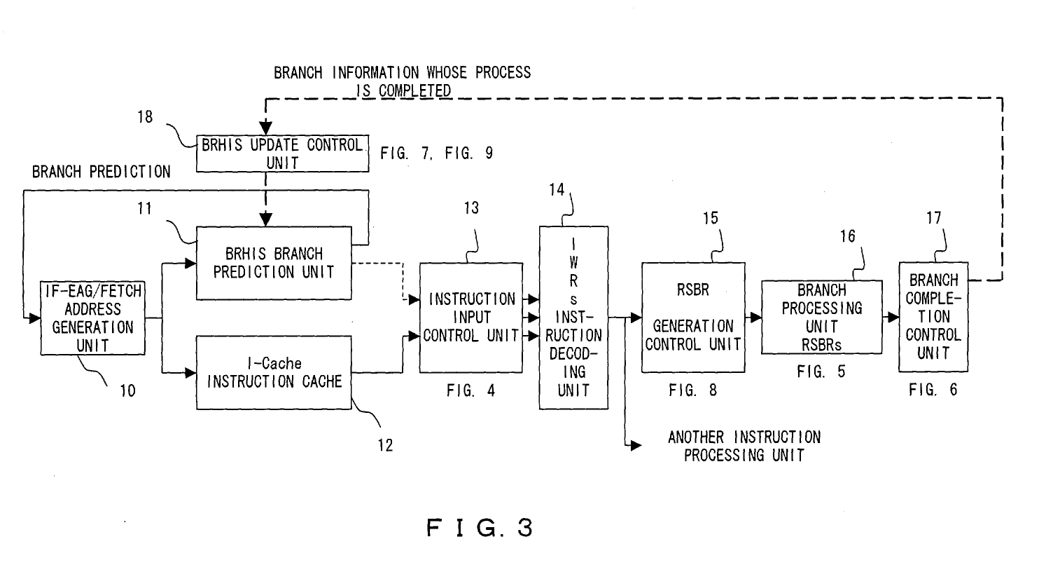

FIG. 3 shows the basic configuration of a data processing device in the preferred embodiment of the present invention.

The data processing device of this preferred embodiment is of super scalar type and can simultaneously process three instructions. It is assumed that an instruction fetching unit sets at maximum three instructions in IWR (Instruction Word Register) 0 through IWR2 for that purpose. It is also assumed that there are three instruction word lengths of two, four and six bytes. However, it is assumed that instruction six bytes long are set only in IWR0 (instruction word lengths other than 2, 4, and 6 bytes are divided into at least two groups and a part of it is set in subsequent cycles). Expression is sometimes input in units of half-words (therefore, there are three half-words of one, two and three bytes).

In this example, the branch instruction queue of a branch process is assumed to be RSBR. There is the address PC of each piece of branch instruction in each queue of the RSBR. There is BRHIS Hit tag information, which is branch prediction information, and Hit-Way tag information in a branch destination address TPC. This configuration is the same as that of Japanese Patent Laid-open Publication No. 2000-172503. This preferred embodiment further comprises Hit-Offset and is indicated by offset information sent from the instruction address PC in a position where a branch has been predicted. Therefore, if a branch is normally predicted by a branch instruction, the Hit-Offset indicates 0.

However, in a specific type of RISC instruction set, all instruction words are constant, for example, four bytes, and it is guaranteed that all instructions fall on instruction word boundaries, which is different from the preferred embodiment of the present invention. In such an instruction set, a branch prediction position always falls on an instruction word boundary (Although the branch prediction position could be set to an address not on an instruction word boundary, there is no reason to do so). Therefore, a device for realizing such an instruction set does not require Hit-Offset. Therefore, the application to such an instruction set of the preferred embodiment should be modified by a person having ordinary skill in the art.

In FIG. 3, IF-EAG (Instruction Fetch-Effective Address Generator), that is, a fetch address generation unit 10 calculates the address of an instruction to be fetched. The calculated address is input to a branch prediction unit 11 with a branch history (BHIS) and I-Cache, that is, an instruction cache 12. The branch prediction unit 11 judges whether a branch should be predicted, based on the input address, and when a branch has been predicted, it outputs a predicted branch destination address. The predicted branch destination address is transferred to the fetch address generation unit 10 and is input to the instruction cache 12 without applying any process to the address. A signal indicating that a branch has been predicted, which is output by the branch prediction unit 11, is input to an instruction input control unit 13.

The instruction cache 12 extracts an instruction to be executed from the input address and inputs the instruction to the instruction input control unit 13. The instruction input control unit 13 transfers the input instruction to IWR, that is, an instruction reading unit 14 together with information about whether a branch has been predicted and instructs how to read the instruction. After the instruction reading unit 14 has read the instruction, it is transferred to a corresponding instruction processing unit. However, if it is a branch instruction, the instruction is input to an RSBR generation control unit 15 controlling the generation of branch instruction queues RSBR. A branch instruction queue RSBR is generated in a branch processing unit 16 and a branch instruction process is performed in order.

The result of the branch instruction process in the branch processing unit 16 is transferred to a branch completion control unit 17. The branch completion control unit 17 judges whether the branch prediction was accurate and transfers the branch information to a BRHIS update control unit 18. The BRHIS update control unit 18 updates the branch history of the branch prediction unit 11, based on the obtained branch information.

When an instruction is set in IWR, simultaneously the branch prediction result is analyzed and sent for each instruction. Then, Hit-Offset is transferred to RSBR together with the branch prediction information, including Hit-Way related to the branch prediction.

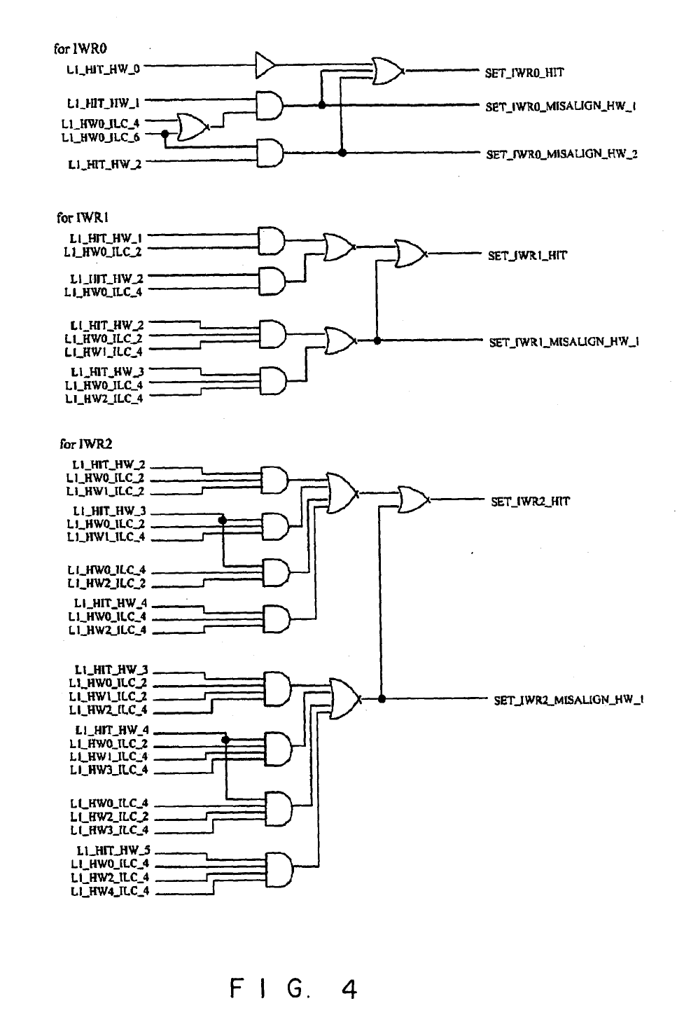

FIG. 4 shows an example of a circuit for generating BRHIS-Hit and Hit-Offset (MISALIGN Half-Word). The circuit shown in FIG. 4 is provided for the instruction input control unit 13 shown in FIG. 3.

In FIG. 4, a signal L1_HWm_ILC_n indicates that the word length of an instruction located at a half-word distance m from an instruction extraction start point (if the position is on an instruction boundary) is n (In this case, n is one of 2, 4 and 6, and indicates the length of the used instruction word. m indicates how far away the branch instruction is from the instruction extraction position in units of half-words (for example, two half-words)). A signal L1_HIT_HW_p indicates that the branch instruction is located at a half-word distance p from the instruction extraction starting point.

Even when a branch has not been predicted on an instruction boundary, the fact that branch prediction has not been conducted is judged by detecting the Hit of the corresponding instruction (SET_IWRx_HIT) and simultaneously by sending a signal SET_IERx_MISALIGN_HW_y.

Specifically, if in a circuit “for IWR0” shown at the top in FIG. 4, a logical value L1_HIT_HW_{—}0 indicating that an instruction extraction position is on an instruction word boundary is input as true, a logical value SET_IWR0_HIT indicating that IWR0 is hit holds true. If an instruction whose instruction word length is four or six bytes, is located at a half-word distance 0 from an instruction extraction position (L1_HW_{—}0_ILC_{—}4, 6) and another instruction prediction position whose instruction word length is four or six bytes, is located at a half-word distance 1 from an instruction extraction starting point, the logical value SET_IWR0_HIT holds true and simultaneously a logical value SET_IWR0_MISALIGN_HW_{—}1 holds true. Similarly, if a branch instruction is located at a half-word distance 2 from an instruction extraction starting point (L1_HIT_HW_{—}2), and an instruction whose instruction word length is six, is located at a half-word distance 0 from the instruction extraction position, a logical value SET_IWR0_MISALIGN_HW_{—}2 indicating that there is misalignment of half-word distance 2 (branch prediction is not being conducted on an instruction word boundary) holds true. However, in either case, the logical value SET_IWR0_HIT holds true in order to indicate that branch prediction has been conducted.

As described above, when signals shown in FIG. 4 are read, the following information is obtained.

In the case of a circuit “for IWR1”, the obtained information is as follows:

(1) If a branch is predicted at a half-word distance 1, an instruction whose word length is two, is located at a half-word distance 0, it is judged that the instruction is misaligned and a logical SET_IWR1_HIT indicating that branch prediction has been conducted holds true.

(2) If a branch is predicted at a half-word distance 2, an instruction whose word length is four, is located at a half-word distance 0, it is judged that the instruction is not misaligned and the logical SET_IWR1_HIT holds true.

(3) If a branch is predicted at a half-word distance 2, and an instruction whose word length is two and another instruction whose word length is four, are located at half-word distances 0 and 1, respectively, it is judged that the two instructions are misaligned and logical values SET_IWR1_HIT and SET_IWR1_MISALIGN_HW_{—}1 hold true (in this case, the word lengths of the first and second instructions are two and four, respectively, and branch prediction is being conducted at the center of the second instruction).

(4) If a branch is predicted at a half-word distance 3, and two instructions whose word lengths are each four, are located at half-word distances 0 and 2, respectively, it is judged that the two instructions are misaligned and the logical values SET_IWR1_HIT and SET_IWR1_MISALIGN_HW_{—}1 hold true.

Furthermore, in the case of a circuit “for IWR2”, the following information is obtained.

(1) If a branch is predicted at a half-word distance 2 and two instructions whose word length is two each are located at half-word distances 0 and 1, it is judged that the two instructions are aligned and a logical value SET_IWR2_HIT holds true.

(2) If a branch is predicted at a half-word distance 3, and an instruction whose word length is two and another instruction whose word length is four, are located at half-word distances 0 and 2, respectively, it is judged that the two instructions are aligned and the logical value SET_IW2_HIT holds true.

(3) If a branch is predicted at a half-word distance 3, and an instruction whose word length is four and another instruction whose word length two, are located at half-word distances 0 and 1, respectively, it is judged that the two instructions are aligned and the logical value SET_IWR2_HIT holds true.

(4) If a branch is predicted at a half-word distance 4 and two instructions, whose word lengths are each four, are located at half-word distances 0 and 2, respectively, it is judged that the two instructions are aligned and the logical value SET_IWR2_HIT holds true.

(5) If a branch is predicted at a half-word distance 3, and two instructions whose word lengths are each two, are located at half-word distances 0 and 1, respectively, it is judged that the two instructions are misaligned and logical values SET_IWR2_HIT and SET_IWR2_MISALIGN_HW_{—}1 hold true.

(6) If a branch is predicted at a half-word distance 4, and an instruction whose word length is two, another instruction whose word length is four and another instruction whose word length is four, are located at half-word distances 0, 1 and 3, respectively, it is judged that the three instructions are misaligned and the logical values SET_IWR2_HIT and SET_IWR2_MISALIGN_HW_{—}1 hold true.

(7) If a branch is predicted at a half-word distance 4, and an instruction whose word length is four, another instruction whose word length is two and another instruction whose word length is four, are located at half-word distances 0, 2 and 4, respectively, it is judged that the three instructions are misaligned and the logical values SET_IWR2_HIT and SET_IWR2_MISALIGN_HW_{—}1 hold true.

(8) If a branch is predicted at a half-word distance 5, three instructions whose word lengths are each four, are located at half-word distances 0, 2 and 4, respectively, it is judged that the three instructions are misaligned and the logical values SET_IWR2_HIT and SET_IWR″_MISALIGN_HW_{—}1 hold true.

Such information is transferred to RSBR together with another branch prediction information tag. A configuration used to transfer such information to RSBR together with another branch prediction information tag is already known.

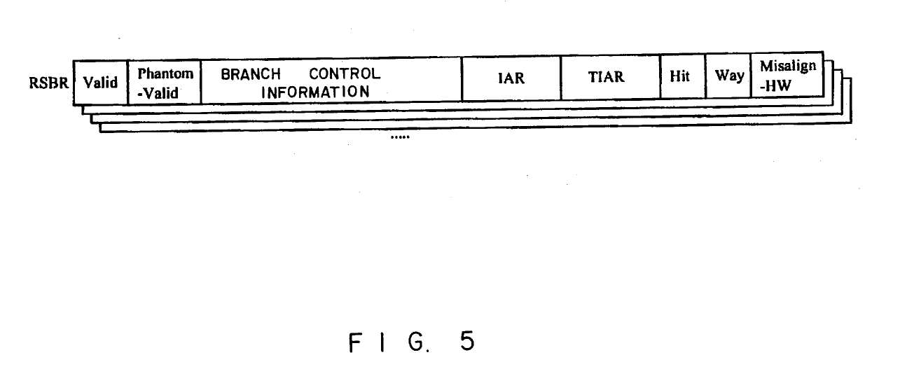

FIG. 5 shows an example of the structure of a queue RSBR for executing branch instructions and controlling phantoms. The RSBR shown in FIG. 5 is provided for the branch processing unit 16 shown in FIG. 2.

The RSBR comprises a valid flag indicating the validity of an entry in a queue RSBR, a Phantom-Valid flag indicating whether the entry is a phantom entry, branch control information describing a conditional branch address, branch conditions and the like, the address IAR of branch prediction instruction, a branch destination instruction address TIAR, a section Hit for storing the SET_IWRy_HIT (in this case, y is an integer for identifying IWR), a section Way indicating the WAY of a branch history and a section Misalign-HW storing signals indicating the misalignment shown in FIG. 4. The data in section Misalign-HW is valid only when the entry of the RSBR is a phantom entry.

The flag Phantom-Valid of the RSBR is set using a technology disclosed in Japanese Patent Laid-open Publication No. 2000-181710 described earlier.

When a branch process or a phantom entry process is completed in the RSBR, the completion is reported to the branch history.

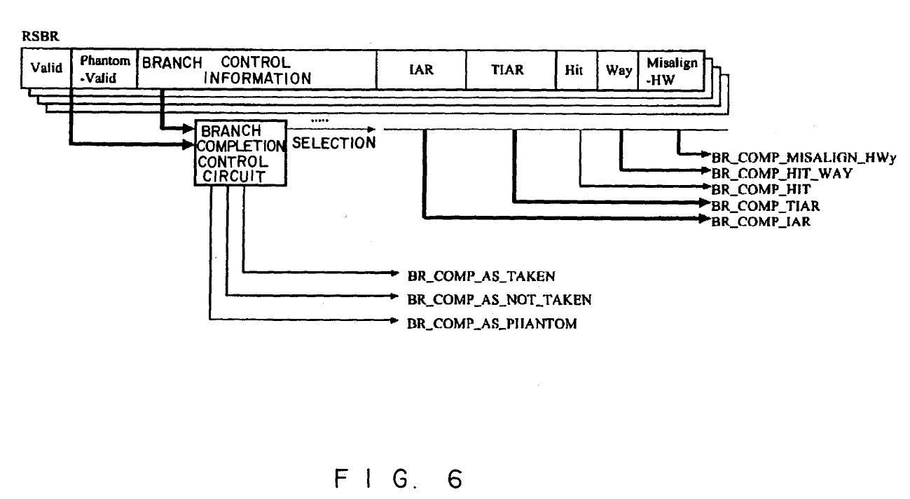

FIG. 6 shows an operation to report the branch execution completion. The circuit shown in FIG. 6 is provided for the branch completion control unit 17 shown in FIG. 3.

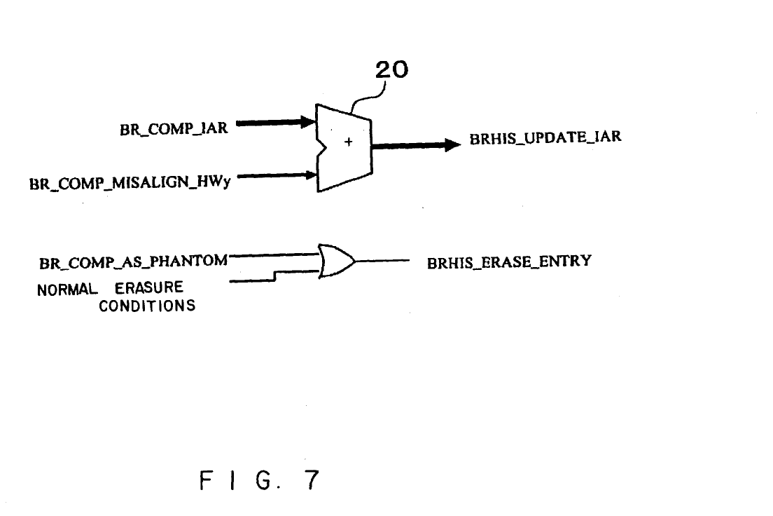

FIG. 7 shows an example of a circuit for generating an entry erasure instruction signal. The circuit shown in FIG. 7 is provided for the BRHIS update control unit 18 shown in FIG. 3.

When a phantom entry process is completed, a branch completion control circuit sends the address BR_COMP_IAR<0: 31> of the completed instruction, a WAY position BR_COMP_HIT_WAY<1: 0> where BRHIS Hit is detected, BR_COMP_MISALIGN_HW_y indicating that instruction is misaligned and other control flags as requested to the BRHIS update control unit together with BR_COMP_AS_PHANTOM indicating that the relevant instruction is a phantom entry.

In FIG. 7, in the case of aligned branch prediction, since a branch is predicted on an instruction boundary, an entry position where Hit is detected is BR_COMP_IAR<0: 31>. However, if the relevant instruction is a phantom entry and misalignment is detected, the home position of an entry that has detected Hit is BR_COMP_IAR<0: 31>+BR_COMP_MISALIGN_HW_y (In this case, y is a half-word distance value and is an integer. In this calculation, if y=1, 2 is added.) An erasure operation can be applied to WAY designated by BR_COMP_HIT_WAY in the address position determined above.

If a misaligned instruction happens to be a branch instruction, BR_COMP_AS_TAKEN (when control flow branches) or BR_COMP_AS_NOT_TAKEN (when control flow does not branch) is sent and an aligned branch process is performed. In this case, update can be exercised over an address to which misalignment information is added. Except for adding misalignment information, the prior art is used.

When either normal erasure conditions or BR_COMP_AS_PHANTOM indicating that the instruction is a phantom entry is input, the circuit shown at the bottom of FIG. 7 sends a signal BRHIS_ERASE_ENTRY reporting that the entry in the branch history should be erased. The circuit shown at the top of FIG. 7 calculates the entry whose branch history should be erased. In this case, an address BR_COMP_IAR is input and an adder 20 adds an address BR_COMP_MISALIGN_HWy for a half-word distance that is represented by a value y to the input address BR_COMP_IAR and outputs BRHIS_UPDATE_IAR.

In this way, a phantom entry is specified and an erase request signal is prepared for each phantom entry to be erased of phantom entries in the branch history. This erase request signal is handled like a conventional branch history entry erase request and the phantom entry is erased using entry erasure means of the conventional branch history.

So far a preferred embodiment that can completely erase phantom entries is described. Conversely, a preferred embodiment that realizes an instruction pre-fetch effect by intentionally generating a phantom entry is described below.

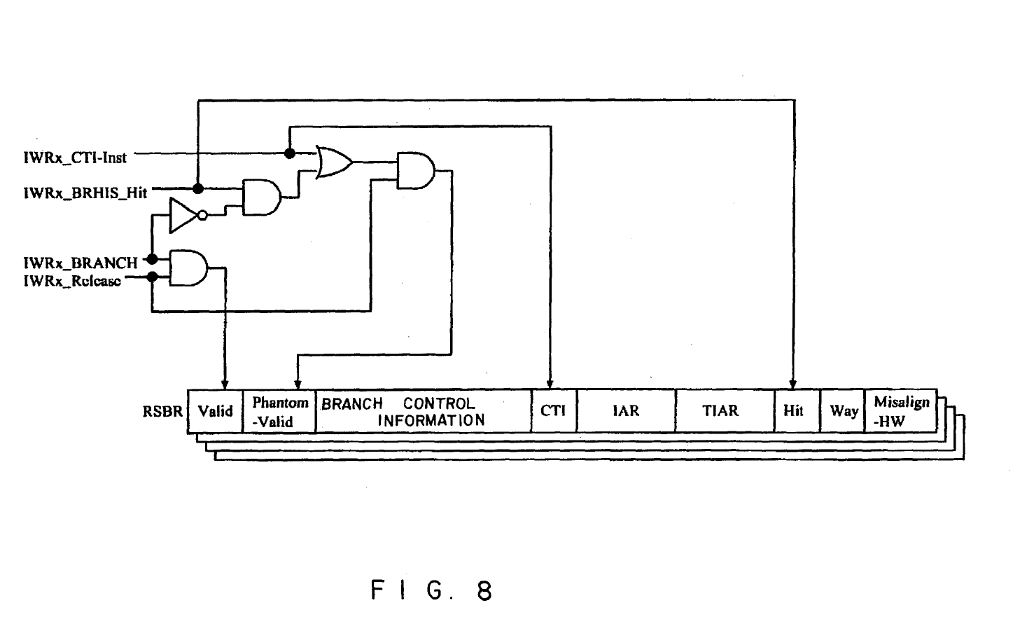

FIG. 8 shows the configuration for intentionally generating a phantom entry. This circuit is provided for the RSBR generation control unit shown in FIG. 3.

If an instruction is found to be a complex instruction that is micro code or emulated by firmware (branch instruction that is not executed at high speed) or non-branch instruction that is processed by the RSBR and branches control flow (such as an instruction that requires exception handling or an instruction to directly rewrite the program counter; in FIG. 8, IWRx_CTI_INST) when the instruction is decoded and issued (in this case, the process is allowed to start by IWRx_Release), an entry equivalent to a phantom entry is created in the RSBR. In this case, a tag (in FIG. 8, CTI field) indicating that the relevant instruction is an intentionally created phantom entry is registered, and when a phantom entry is created, the fact is reported to the BRHIS update unit. The RSBR is designed to receive the branch destination of the complex instruction from the processing unit. Therefore, when a phantom entry is created, a branch destination address BR_COMP_TIAR is sent to the BRHIS.

In FIG. 8, if the instruction is a non-instruction that branches an instruction address (IWRx_CTI_Inst) or if the branch history is hit (IWRx_BRHIS_Hit), the instruction is not a branch instruction (logical reverse of IWRx_BRHIS_Hit) and IWRX_Release (process start permit after instruction decoding finishes) is issued, a flag is raised in Phantom-Valid. Since the branch history is hit, a flag is raised in Hit flag too. If IWRx_BRANCH and IWRx_Release are input, it is judged that the entry is valid and a flag Valid is raised.

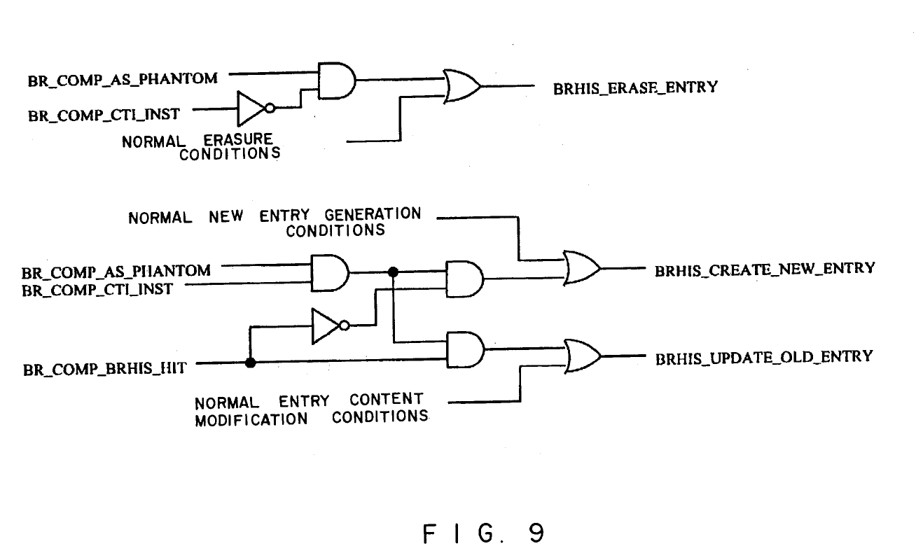

FIG. 9 shows an example of a circuit for generating a BRHIS update signal used when a phantom entry is intentionally created. The circuit shown in FIG. 9 is provided for the BRHIS update control unit 18 shown in FIG. 2.

On receipt of a notice BR_COMP_AS_PHANTOM with the tag, the BRHIS update control unit 18 does not erase the entry and updates aligned branch prediction information. Specifically, if there is the entry (BRHIS Hit), the BRHIS update control unit 18 updates the entry as requested. If there is no entry (Not hit), the unit 18 creates a new entry. The prior art is used for the other control, such as using BR_COMP_TIAR sent from the RSBR as a branch destination address to create/update an entry.

In FIG. 9, if the entry in the branch history is a phantom entry (BR_COMP_AS_PHANTOM) and is a branch instruction (logical inverse of BR_COMP_CTI_INST), an instruction to erase the entry of the branch history (BRHIS_ERASE_ENTRY) is output. If the entry is a phantom entry (BR_COMP_AS_PHANTOM), it is not a branch instruction (BR_COMP_CTI_INST) and the branch history is not hit (logical inverse of BR_COMP_BRHIS_HIT), instruction to intentionally create a phantom entry (BRHIS_CREATE_NEW_ENTRY) is sent together with the normal generation conditions of a new entry. If the branch history is hit, the entry is a phantom entry and is not a branch instruction, an instruction to keep the phantom entry (BRHIS_UPDATE_OLD_ENTRY) is output.

By doing so, when the next time there is an instruction fetch request corresponding to the instruction address, the entry is read and a branch prediction instruction is fetched. For example, even when an execution unit cannot promptly use the entry, instruction pre-fetching is available. In this way, since an operational equivalent to a pre-fetch request is made for a cache, performance can be improved.

As described above, according to this method, a phantom entry can be completely erased and the performance degradation of a branch history can be avoided. By positively using this function, control that brings about an instruction pre-fetching effect can be exercised over even a complex control transfer instruction and performance can be improved accordingly.

What is claimed is:

1. A data processing device with a branch prediction mechanism, comprising:
a judgment unit judging whether a target instruction is a branch instruction; and
a phantom erasure unit erasing a branch prediction entry corresponding to an instruction to be stored in the branch prediction mechanism if it is judged that the target instruction is not a branch instruction.

2. A data processing device with a branch prediction mechanism, comprising:
a queue unit decoding an instruction and issuing it for execution;
a detection unit judging whether an instruction for where a branch has been predicted falls on a boundary of an instruction word stored in the queue unit when the branch has been predicted for the instruction stored in the queue unit; and
a misalignment erasure unit erasing a branch prediction entry to be stored in the branch prediction mechanism on which the branch prediction is based, if it is judged that the instruction for which where a branch has been predicted does not fall on a boundary of an instruction word.

3. The data processing device according to claim 2, wherein if it is found that an instruction for which a branch is to be predicted does not fall on an actual instruction boundary, the branch processing mechanism stores information specifying an offset sent from the boundary and erases a branch prediction entry stored in the branch prediction mechanism, using the offset.

4. A data processing device with a branch prediction mechanism, comprising:
a phantom target instruction detection unit detecting a branch instruction that is not executed at high speed or a non-branch instruction that branches control flow; and
a phantom entry generation unit creating a branch prediction entry in a branch prediction mechanism, based on an entry corresponding to the instruction detected by the phantom target instruction detection unit and adding it to a branch history,
wherein instruction process speed is improved by performing instruction pre-fetching using the branch prediction entry.

5. A method for erasing an unnecessary entry of branch prediction entries in a data processing device with a branch prediction mechanism, comprising:
judging whether a target instruction is a branch instruction; and
erasing a branch prediction entry corresponding to an instruction stored in the branch prediction mechanism if it is judged that the target instruction is not a branch instruction.

6. A method for erasing an unnecessary entry of branch prediction entries in a data processing device with a branch prediction mechanism, comprising:
decoding an instruction and issuing it for execution;
judging whether a target instruction falls on a boundary of the instruction word stored in the queue step when a branch is predicted for the instruction stored in the decoding and issuing step; and
erasing a branch prediction entry to be stored in a branch prediction mechanism on which the branch prediction is based, if it is judged that the target instruction does not fall on a boundary of an instruction word.

7. The method according to claim 6, wherein if it is found that a target instruction does not fall on an actual instruction boundary, the branch processing mechanism stores information specifying an offset from the boundary and erases a branch prediction entry stored in the branch prediction mechanism, using the offset.

8. A method for processing instructions at high speed in a data processing device with a branch prediction mechanism, comprising:
detecting a branch instruction that is not executed at high speed or a non-branch instruction that branches control flow; and
creating a branch prediction entry to be stored in the branch prediction mechanism, based on an entry corresponding to the instruction detected in the detection step and adding it to the branch history,
wherein instruction process speed is improved by performing instruction pre-fetching using the branch prediction entry.
